(19) United States
(12) Patent Application Publication
(10) Pub. No.: US 2019/0137384 A1
(43) Pub. Date: May 9, 2019

(54) OPTICAL SENSOR, SYSTEM AND METHODS

(71) Applicant: TEKNOLOGIAN TUTKIMUSKESKUS VTT OY, Espoo (FI)

(72) Inventors: Sanna AIKIO, Oulu (FI); Jussi HILTUNEN, Oulu (FI); Christina LIEDERT, Oulu (FI)

(73) Assignee: TENKOLOGIAN TUTKIMUSKESKUS VTT OY, Espoo (FI)

(21) Appl. No.: 16/096,122

(22) PCT Filed: Apr. 12, 2017
(86) PCT No.: PCT/FI2017/050270

§ 371 Date: Oct. 24, 2018

(30) Foreign Application Priority Data
Apr. 25, 2016 (FI) 20165358

(51) Int. Cl. G01N 21/27; G01N 21/31; G01N 21/64; G01N 30/74

(52) U.S. Cl. CPC G01N 21/274; G01N 30/74; G01N 21/645; G01N 21/31

(57) ABSTRACT

There is provided an optical sensor for analyte molecules in a fluid, method for manufacturing an optical sensor, system and method. An optical sensor comprises a fluidic channel for fluid flow, said fluidic channel having a sensing area comprising receptors for reference molecules and the analyte molecules in the fluid, and the sensor comprises at least one calibration area comprising calibration molecules, and the at least one calibration area and the sensing area are arranged in a reading area of the sensor such that the sensor is capable of generating a sensor response, when the reading area is exposed to stimuli.

### FIELD OF THE INVENTION

The present invention relates to sensors for analyte molecules in a fluid and particularly the optical sensors.

### BACKGROUND OF THE INVENTION

There is an increasing need for low-cost quantitative sensors. In addition, also the reader should be low-cost.

Low-cost manufacturing methods, such as roll-to-roll fabrication, inherently produce variations between individual sensor chips that hinder reliable, repeatable and precise signal quantitation.

The variations between low-cost readers causes differences in their sensor responses due to large variation in the properties of the components and differences in their alignment. The use of components and readers with tight specifications would reduce the variations but would also make the cost of the reader too high.

Optical analytical methods are known and widely used. Methods, such as fluorescence, chromatography, reflectance, spectroscopy and colour change, are based on the measurement of the intensity of the generated or reflected light that depends on the concentration of the analyte molecules. However, the intensity of the optical signal is readily affected also by many other factors in the properties of the sensor chip, sample, test conditions and reader, making the reliable and repeatable signal quantification challenging. For example, the intensity of the optical signal is affected by:
Sample flow velocity: Small variations in the dimensions of the fluidic platform or chemical composition of the fluid change the flow velocity of the sample solution affecting to the strength of the generated sensor signal. Also the viscosity of the samples may vary that affect to their flow properties and sensor signal. If external pump is used to induce sample flow, the applied pressure affects the sample flow velocity.
Ageing of the test reagents
Chip storage conditions
Batch to batch variation of the reagent properties (e.g. antibodies, fluorophores)
Batch to batch variation of the reagent concentration
Batch to batch variation of the reagent distribution in the sensor chip
Changes in the emitted intensity of the light sources
Variations in the test conditions, such as temperature that affects the kinetics of the chemical reactions in the sensor chip.

### BRIEF DESCRIPTION OF THE INVENTION

An object of the present invention is thus to provide a sensor, system and method so as to alleviate the above disadvantages. The objects of the invention are achieved by a sensor, system and methods which are characterized by what is stated in the independent claims. The preferred embodiments of the invention are disclosed in the dependent claims.

Some embodiments provide an optical sensor for accurate post-manufacturing sensor response.

### BRIEF DESCRIPTION OF THE DRAWINGS

In the following the invention will be described in greater detail by means of preferred embodiments with reference to the attached drawings, in which

FIGS. 1a, 1b, 1c, 1d and 1e illustrate sensors according to embodiments;

FIGS. 2a to 2c illustrate examples of fluidic channels according to embodiments;

FIGS. 3a and 3b illustrate examples of outlets for fluidic channels according to an embodiment;

FIG. 4 illustrates an example of a calibration area according to an embodiment;

FIGS. 5a and 5b illustrate examples of reference molecule areas according to embodiments;

FIGS. 6a and 6b illustrate examples of sensing areas according to embodiments;

FIG. 6c illustrates an example of molecule binding between a receptor for analyte molecules and an analyte molecule;

FIG. 6d illustrates an example of molecule binding between a receptor for reference molecules and a reference molecule;

FIG. 7 illustrates a system and data flow according to embodiments;

FIG. 8 illustrates a method for manufacturing a sensor according to an embodiment; and

FIG. 9 illustrates a method for processing a post-manufacturing sensor response according to an embodiment.

### DETAILED DESCRIPTION OF THE INVENTION

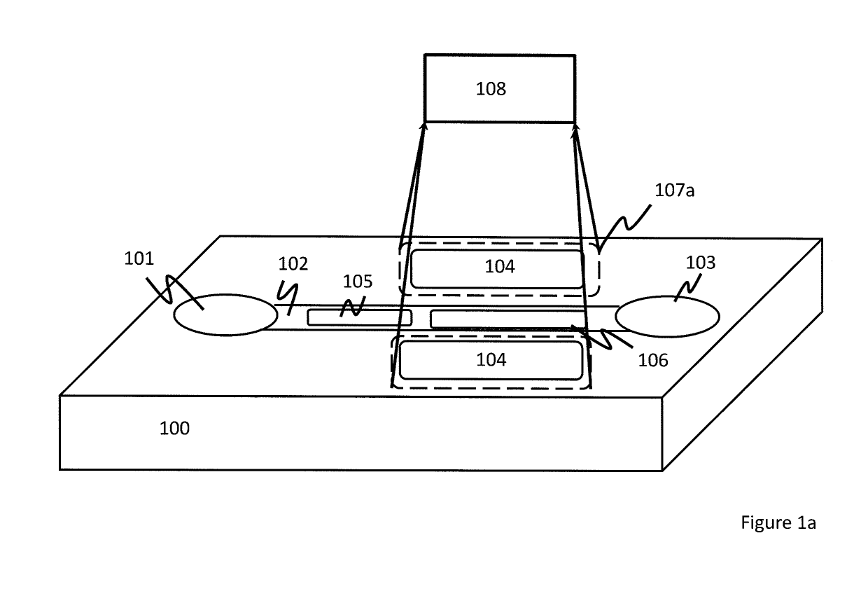

FIGS. 1a, 1b, 1c and 1d illustrate optical sensors according to embodiments. FIGS. 1a and 1c illustrate sensors prior to their exposure to a fluid to be analysed and FIGS. 1b and 1c illustrate sensors after subjecting the sensors to the fluid to be analysed. FIGS. 1a, 1b, 1c and 1d illustrate sensors, comprising an area 105 capable of releasing reference molecules when the area is subject to fluid flow. This area may be referred to as reference molecule area. FIG. 1e illustrates a sensor 140 without the reference molecule area. The sensor may be manufactured without the reference molecule area, when the reference molecules may be supplied from an external source. In one example the reference molecules may be supplied in a fluid to be analysed by the sensor. The sensor of FIG. 1e may be used as the sensor in FIGS. 1a, 1b, 1c and 1d.

Prior to exposure to the fluid to be analysed the sensors may be sensors in manufacturing or manufactured sensors prior to their distribution to the endusers. After the sensors have been distributed to endusers they may be referred to post-manufacturing sensors. The post-manufacturing sensor may be used by the endusers such that the sensor is exposed to the fluid to be analysed.

An optical sensor 100, 110, 120, 130, 140 may comprise a fluidic channel 102 for fluid flow and a sensing area 106 capable of capturing analyte molecules from the fluid flow. The fluidic channel may direct the fluid such that the fluid entering the fluidic channel may flow to the sensing area. The sensing area may be capable of capturing molecules of interest in the fluid. In this way the presence of the captured molecules in the fluid may be detected from light generated or reflected by the captured molecules. The molecules of interest in the analysed fluid may be referred to as analyte molecules.

In an embodiment, the fluidic channel may comprise an area 105 capable of releasing reference molecules when the area is subject to fluid flow. This area may be referred to as reference molecule area. The sensing area 106 may be located downstream from the reference molecule area. In this way, the reference molecules released by the reference molecule area may be captured by the sensing area, when the reference molecules are carried by the fluid downstream to the sensing area. The sensing area may comprise receptors for the reference molecules and receptors for the analyte molecules such that the molecules may be captured.

The sensor may comprise one or more calibration areas 104 comprising calibration molecules. Preferably calibration areas and the sensing area are arranged in a reading area 107a, 107b, 107c, and 107d of the sensor such that the sensor is capable of generating a sensor response, when the reading area is exposed to stimuli. In this way, when the sensor is read by a readout unit 108, 118, 128, 138, a sensor response representing presence of analyte molecules, reference molecules and/or calibration molecules in the reading area of the sensor may be obtained for obtaining accurate post-manufacturing sensor response.

In a sensor prior to exposure to the fluid to be analysed, the reading area may be formed by the one or more calibration areas. On the other hand, on a post-manufacturing sensor the reading area of the sensor may be formed by the one or more calibration areas and the sensing area which are arranged in proximity of each other such that they may be read by a single readout unit and/or a single readout operation performed by separate readout units. Therefore, the reading area may be defined on the basis of the properties of the readout units that are used and whether the calibration areas and sensing areas are arranged such that they may be read by a single readout unit or if more than one readout units are needed. Properties of the readout unit may comprise a reading range and a readable area of the readout unit. The readable area may be large when the distance between the readout unit and the sensor is large and small when the distance between the readout unit and the sensor is small. In an example the readout unit may be a camera, whereby the readable area of the camera may be defined by magnification of the imaging optics and/or the area of camera sensor size.

In one example, the reading area 107b, 107d of a post-manufacturing sensor 110, 130 may be different than a reading area 107a, 107c of the sensor 100, 120 in manufacturing or prior to delivery to the end user. In a sensor prior to delivery to the enduser, the reading area 107a may comprise only the calibration areas 104. On the other hand in the post-manufacturing sensor the reading area 107b, 107d may comprise the calibration areas 104 and the sensing area 106. Accordingly, the sensing area may be omitted from the reading area, before the sensor is delivered to the enduser but the sensing area may be included in the reading area of a post-manufactured sensor.

The sensor response may be light generated or reflected from the calibration molecules, reference molecules and/or analyte molecules. The sensor response type may be fluorescence, chromatography, spectroscopy or colour change. The presence of each of the molecules may be determined on the basis of the intensity of the light generated or reflected from the molecules. Accordingly, responses from calibration molecules, analyte molecules and reference molecules may be different. In an example, the responses of the molecules may be differentated on the basis of the wavelengths of the responses. The stimuli may be provided by a light source capable of causing a sensor response by one or more areas of the sensor. Prior to exposure of the sensor to the fluid, e.g. during manufacturing, the sensor response may comprise light from the calibration area caused by the stimuli. A sensor response of a post-manufacturing sensor may comprise generated or reflected light from the calibration area and the sensing area of the sensor, caused by the stimuli.

A readout unit for reading the sensor response prior to subjecting the sensor to a fluid, e.g. at manufacture, may be referred to a calibration readout unit 108, 128, and a readout unit for reading the sensor response after subjecting the sensors to the fluid to be analysed may be referred to a sensor readout unit 118, 138. The calibration readout unit may be an industrial device adapted to read only the calibration areas of the sensor in a specific environment. The specific environment may be a factory, where the sensor is manufactured. The environment may be relatively fixed in terms of one or more of the following characteristics: humidity, lighting and temperature. The sensor readout unit 118, 138 may be an enduser device adapted to read the calibration areas and the sensing area of the sensor. In contrast to the operating environment of the calibration readout unit, the sensor readout unit may be adapted to operate in various different environments. Accordingly, the adaptation of the sensor readout unit may provide that the sensor readout unit may be capable of operating in environments, where one or more of the following characteristics may vary considerably between different time instants, e.g. hours or days: humidity, lighting and temperature.

In an embodiment, a sensor readout unit 118, 138 may be capable of reading the calibration area, the sensing area and of the sensor 110, 130, and a data storage in the sensor. The data storage may store information identifying the sensor, i.e. a sensor identifier, and data obtained from the calibration areas at manufacture. In one example, the sensor readout unit 118 may be capable of reading an optical code as well as the calibration area and the sensing area. In one example, the sensor readout unit 138 may be capable of reading a discrete memory element as well as the calibration area and the sensing area. The sensor readout unit may have an Radio-Frequency Identification (RFID) reader for reading the discrete memory element via RFID.

In one example, a reading area 107b of a post-manufacturing sensor may comprise a machine readable optical code 112 printed on the sensor. In this way a sensor readout unit 118 may obtain the sensor response and information for identifying the sensor and/or sensor response in a single reading area.

Examples of the readout units comprise cameras and other optical devices that are capable of sensing either visible or invisible light and generating a representation, where intensities of the light in a readable area of the readout unit may be presented. The representation may be a picture that may be readable to human. The readout units may further comprise RFID reading and/or writing functionality provided e.g. by an RFID module.

A stimuli may be a signal that may cause the calibration molecules, reference molecules and/or analyte molecules to generate or reflect a signal of light. The generated or reflected optical signals form the sensor response. The signal may be caused by the generated or reflected light of the molecules that are responsive to the stimuli. Accordingly, the molecules may be fluorescent such that they are capable of absorbing energy from the stimuli for emitting light. The emitted light may have a smaller or longer wavelength than the wavelength of the stimuli. On the other hand, signal may be formed by light reflection or harmonic generation without energy absorption.

The fluidic channel may comprise at least one of an inlet 101 and an outlet 103. The inlet may be capable of receiving the fluid to be analysed for transporting the fluid in the fluidic channel in a downstream direction towards a sensing area. The outlet may be capable of collecting or aspirating the fluid that has travelled in the fluidic channel past the sensing area. The outlet may have a pump or an external pump may be provided for aspirating the fluid from the outlet and the fluidic channel. Fluidic channel may comprise also sample treatment functionalities, such as analyte molecule binding with optically active molecules.

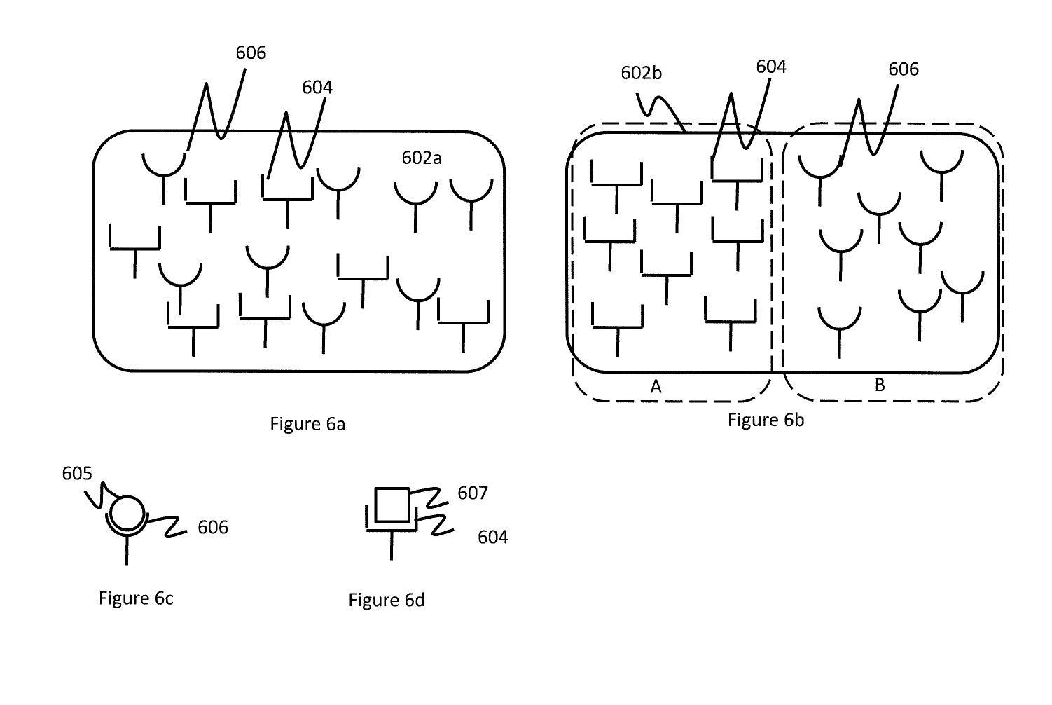

In an embodiment, a sensor 100, 110, 120, 130 may comprise at least two calibration areas arranged on opposite sides of the fluidic channel 102 such that the sensing area is between the calibration areas. With this arrangement, interpolation methods can be used to produce corrected reference data and corrected analyte data 708 in processing unit 705 described in FIG. 7.

In an embodiment a sensor response may be generated, when the reading area is exposed to stimuli prior to subjecting the sensor 100, 120 to a fluid and a different sensor response may be generated, when the reading area is exposed to the stimuli after subjecting the sensor 110, 130 to the fluid. Stimuli may be light illumination. In this way the sensor response of the sensor may be obtained in two events that are separated in time. The sensor response generated prior to subjecting the sensor to a fluid may be used for compensating the sensor response generated after subjecting the sensor to the fluid. In this way effects of the environment, readout unit capabilities and condition of the sensor to the sensor response may be compensated.

In an embodiment a sensor response may be measured prior to exposure of the sensor to the fluid to be analysed. This may take place during manufacturing of the sensor. The measured sensor response of the sensor may be stored to a network storage or a local memory. FIGS. 1b and 1d illustrate examples of local memories 112, 122 capable of storing the measured sensor response. The local memory 112 may be a machine readable optical code, for example a bar code. The bar code may be a one-dimensional bar code or two-dimensional bar code for example. Typically a two-dimensional bar code may be a QR code. The machine readable optical code may be printed on the sensor during manufacturing, for example by a laser printing device. On the other hand the local memory 122 may be a discrete memory element with RFID access, which is integrated to the sensor. The measured sensor response may be written to the discrete memory element by utilizing the RFID access to the memory element.

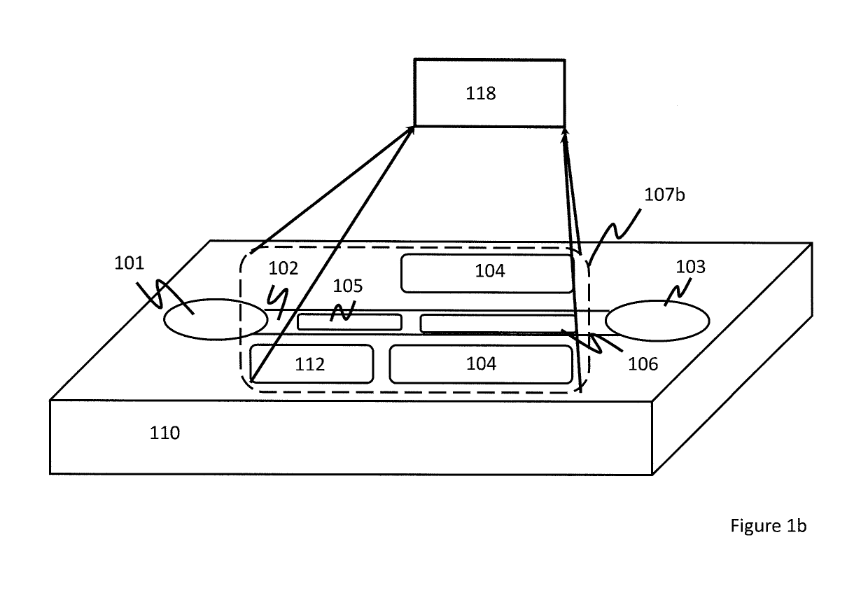

FIGS. 2a to 2c illustrate examples of fluidic channels according to embodiments. The fluidic channel may be capable of delivering fluid, e.g. a liquid sample, in the channel. The fluid may flow in the fluidic channel towards a sensing area of a sensor. The direction of the fluid is illustrated by arrows in the FIGS. 2a to 2c. FIG. 2a illustrates a fluidic channel 202 having a three dimensional (3D) hollow structure. The 3D structure may be formed by a top 204, bottom 206 and side portions 207 which are around a space for forming a hollow structure for passage of fluid between the top, bottom and side portions. FIG. 2b illustrates a fluidic channel 212 formed by a chemically modified surface or volume 214. The chemically modified surface or volume may be for example paper or nitrocellulose that can adsorb used molecules and has suitable chemistry and material structure to transport liquid. FIG. 2c illustrates a fluidic channel 222 formed by a blank surface or volume. The blank surface may be shaped according to the shape of the sensor, when the blank surface or volume is positioned the sensor. In this way the shape of the sensor may determine an area for the fluid flow. The blank surface or volume may be for example cut paper or nitrocellulose that is processed, for example, by die cutting or dicing. The fluidic channels may be made various materials, for example glass, silicon, plastics, paper and nitrocellulose.

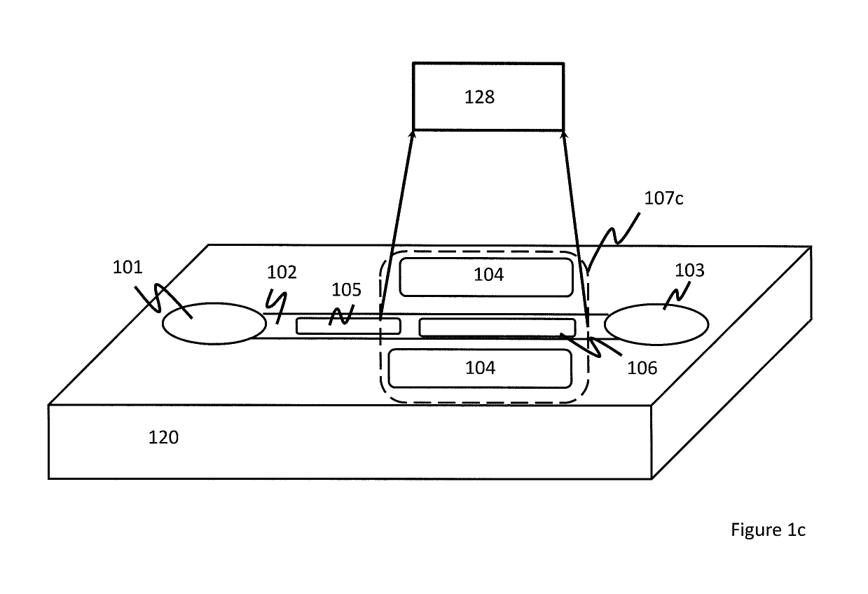

FIGS. 3a and 3b illustrate examples of outlets 300a, 300b for fluidic channels 302 according to an embodiment. Fluid may enter the outlet after the fluid has travelled in the fluidic channel past a sensing area. In the example of FIG. 3a, the outlet may comprise a reservoir 303. In this way molecules that are not bound to the sensing area may be collected from the fluidic channel and away from the sensing area. The reservoir may be capable of accommodating the unbound molecules for example by providing a sufficient volume for the molecules. In the example of FIG. 3b, the outlet may comprise 304 a connection to an external pump that may aspirate the fluid. The direction of the fluid is illustrated by arrows.

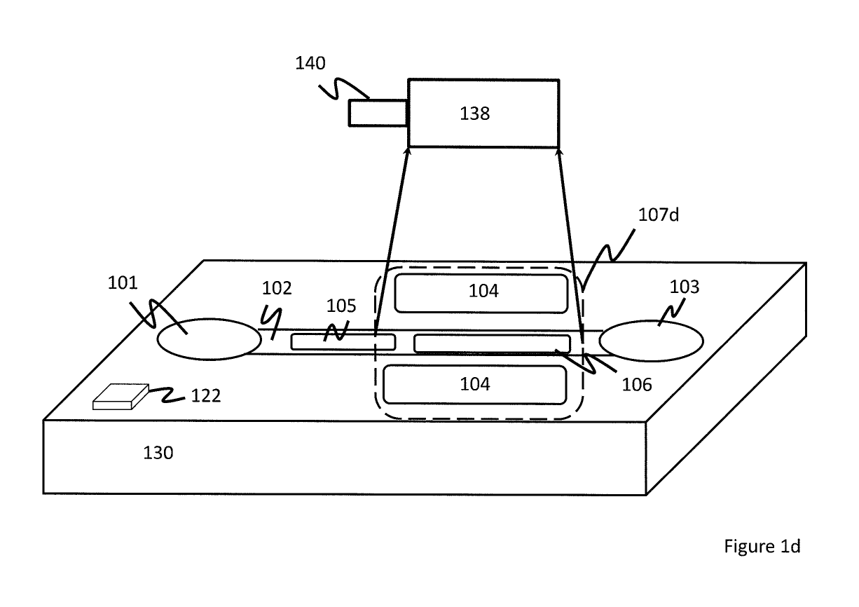

FIG. 4 illustrates an example of a calibration area 404 according to an embodiment. The calibration area may comprise calibration molecules 406. Examples of the calibration molecules are molecules, such as fluorophores, that are capable of generating a spectral response. The calibration area may have one, two, three, four or more types of calibration molecules. In the illustration, two types of calibration molecules are shown identified by numerals 1 and 2. Each type of the calibration molecules may be capable of generating a different spectral response. The spectral response may be visible or invisible light, whereby the calibration molecules may be capable of generating a spectral response corresponding to a specific colour of the visible or invisible light.

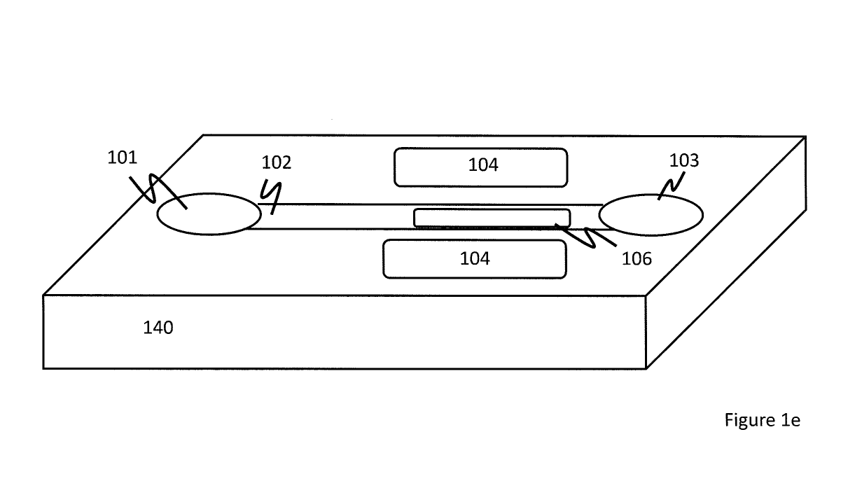

FIGS. 5a and 5b illustrate examples of reference molecule areas 505a, 505b according to embodiments. In FIG. 5a a reference molecule area 505a comprises reference molecules 506 bound to a capture molecule 507. In FIG. 5b a reference molecule area 505b comprises reference molecules 508 without a capture molecule. The reference molecules in the reference molecule areas are capable of moving from the reference molecule area downstream to the sensing area, when the reference molecule area is exposed to fluid in the fluidic channel. In this way the reference molecules may be captured in the sensing area and be read by a readout unit.

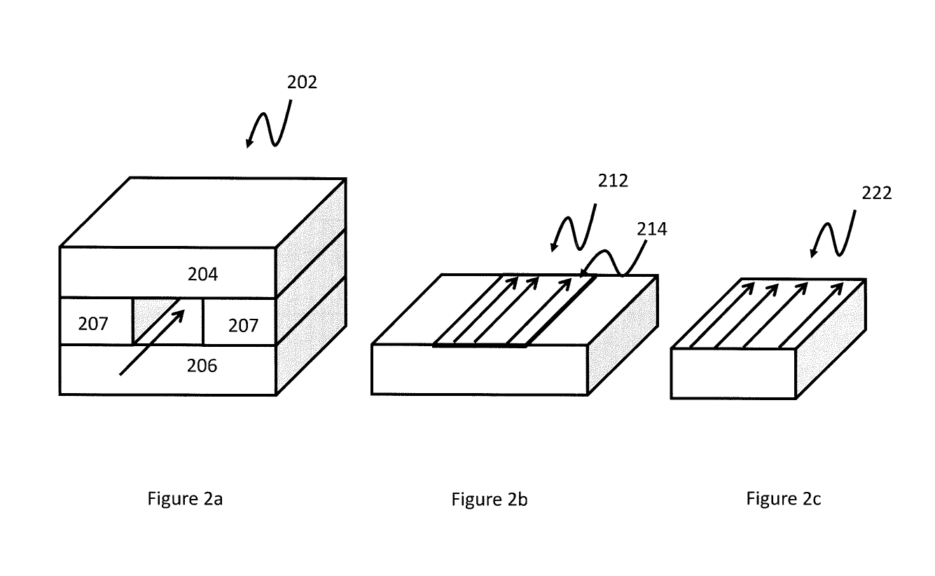

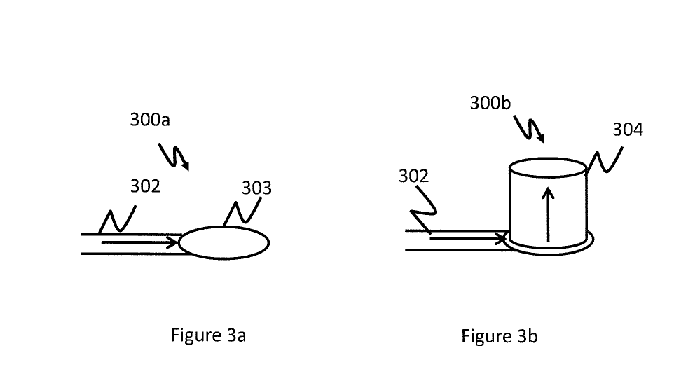

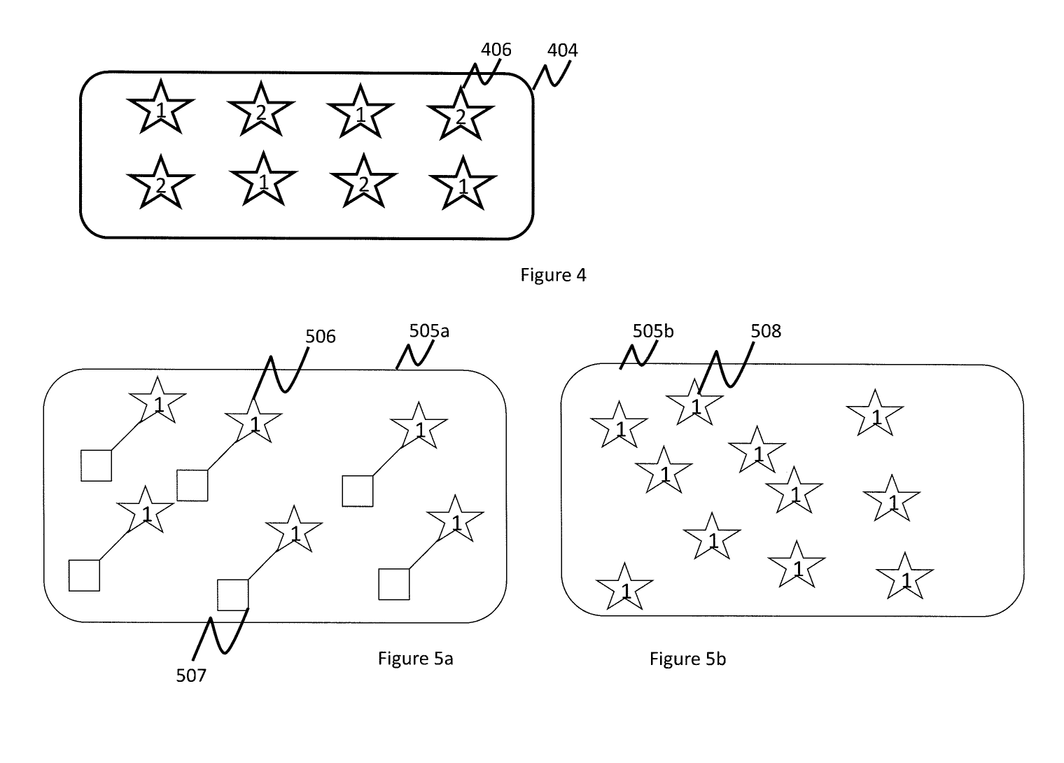

FIGS. 6a and 6b illustrate examples of sensing areas 602a, 602b according to embodiments. FIG. 6c illustrates an example of molecule binding between a receptor 606 for analyte molecules and an analyte molecule 605 and FIG. 6d illustrates an example of molecule binding between a receptor 604 for reference molecules and a reference molecule 607.

Referring to FIG. 6a, a sensing area 602a comprises receptors 606 for analyte molecules and receptors 604 for reference molecules. The receptors 604, 606 may be distributed substantially evenly on the sensing area. In this way analyte molecules and reference molecules may be captured evenly across the sensing area. Responses to stimuli from analyte molecules and reference molecules may be different. Since the distribution of the analyte molecules and reference molecules is substantially even in the sensing area, the responses may be wavelength multiplexed by the sensing area. A sensor response read from the sensing area may be processed for example by wavelength de-multiplexing such that the reference molecules and analyte molecules may be detected from the sensor response.

Referring to FIG. 6b, a sensing area 602b comprises receptors 606 for analyte molecules and receptors 604 for reference molecules. The receptors 604, 606 may be distributed into different parts A, B, of the sensing area. This arrangement of capture molecules allows spatial separation of the analyte molecules and reference molecules by the sensing area. Thanks to the spatial separation, the reference molecules and analyte molecules may be detected from a sensor response even without wavelength de-multiplexing.

FIG. 7 illustrates a system and data flow according to embodiments. The system may comprise a storage 703 for storing sensor-specific sensor responses prior to subjecting a sensor to a fluid. The storage may be a network storage or a local memory. The network storage may be provided by a cloud service. The sensor responses may be measured 702 at manufacturing of the sensor. The sensor responses measured prior to subjecting a sensor to a fluid, at manufacture, may be read by a calibration readout unit 108, 128.

The system may further comprise a sensor readout unit 118, 138 for obtaining a sensor response 706 after subjecting the sensor to the fluid, at post-manufacture. The obtained sensor response and information identifying the sensor may be sent from the sensor readout unit to a processing unit 705.

The obtained sensor response may be referred to a post-manufacturing sensor response of the sensor. The sensor response may be obtained by the sensor readout unit from the calibration area and from the sensor area. The sensor readout unit may be further capable of obtaining information identifying the sensor from an optical code or a discrete memory element in the sensor as described above with FIGS. 1b and 1d. The information identifying the sensor may be included in the sensor response 706.

The system may further comprise a processing unit 705 for processing the obtained post-manufacturing sensor response, and an enduser component 711 for delivering the processed sensor response values to the enduser.

The storage, the sensor readout unit, the processing unit and the enduser component may be operatively connected to cause obtaining a post-manufacturing sensor response of the sensor, said sensor response comprising values representing presence of analyte molecules and reference molecules and calibration molecules in the reading area of the sensor. A compensated sensor response 708 of the obtained sensor response may be determined by the processing unit 705, wherein the values of the sensor response are compensated on the basis of the sensor-specific sensor response measured 702 at manufacturing of the sensor. The compensated sensor response may be caused to be displayed to the enduser by the enduser component 711.

In an embodiment, at processing unit 705, data 704 from the calibration area obtained during manufacture may be compared with the data 706 from calibration area at post-manufacture to establish a sensor specific and sensor readout unit specific correction factor or spatial correction function.

In an embodiment, a compensated sensor response 708 of the obtained sensor response may be determined by the processing unit 709. The compensation may comprise that the sensor readout comprising a signal produced by the reference molecules in the sensor area is corrected by using the sensor specific correction factor or spatial correction function and a corrected reference signal 708 is obtained. The sensor response may also comprise signal produced by the analyte molecules in the sensor area. The signal produced by the analyte molecules in the sensor area may be corrected by using the sensor specific correction factor or spatial correction function, whereby a corrected analyte signal 708 is obtained.

In an embodiment a compensated sensor response may be a quantitative signal 710. The quantitative signal may be computed by processing unit 709 by calculating the ratio between the value of the corrected analyte signal and the value of the corrected reference signal. In this way the post-manufacturing sensor response may be determined quantitatively that is proportional to sample concentration. Ratio of the analyte molecules and the reference molecules indicated by the sensor response may be maintained despite variation during manufacture or test conditions.

In an embodiment the system is caused to determine one or more enduser-specific parameters and to adjust a compensated sensor response on the basis of the enduser-specific parameters. The enduser-specific parameters may be obtained from the enduser component or a database storing enduser data comprising at least information identifying endusers and enduser-specific parameters. The enduser specific parameters may comprise a definition of enduser subscription and a request from the enduser for a sensor response. The enduser-specific parameters allow that the compensated sensor response may be customized according to the enduser.

In one example different endusers, e.g. a patient and a doctor may have different enduser-specific parameters. A compensated sensor response customized for the patient may be an indication capable of indicating the patient if analyte molecule levels are within acceptable limits or not. A compensated sensor response customized for the doctor may be a fully quantified numerical result for diagnostic purposes. In this way the patient may be provided and doctor may be provided different compensated sensor responses to facilitate home testing by the patient and diagnostics by the doctor. In an embodiment the system may be local to the sensor. In a local system, the storage units may be local to the sensor. The processing unit 705 may be a computing device capable of processing data and serving as a sensor readout unit. In one example the computing device may be a smart phone or a tablet computer that has a camera serving as a sensor readout unit for obtaining the post-manufacturing sensor response and possibly the sensor identifier on the sensor. When the sensor identifier is on an RFID readable memory element, the smart phone or tablet computer comprising an RFID reader and a camera may serve as the sensor readout unit for obtaining the sensor identifier as well as the post-manufacturing sensor response.

In an embodiment the system may be a cloud service and capable of communicating data such as sensor responses, information identifying the sensor over an internet connection. The connection to a sensor may be an indirect connection, where a processing unit, e.g. computing device capable of processing data and serving as a sensor readout unit, may be used for obtaining a post-manufacturing sensor response and information identifying the sensor, i.e. a sensor identifier, for delivering the sensor response and the sensor identifier to the cloud service. The computing device may send the post-manufacturing sensor response and a sensor identifier to the cloud service for processing and receive as a response a compensated sensor response from the cloud service. Accordingly, the cloud service may be an Internet-based computing service that provides shared processing resources for processing the sensor responses as well as network storage for storing the sensor response and the sensor identifier. The computing device may further serve as an enduser component for displaying the compensated sensor response.

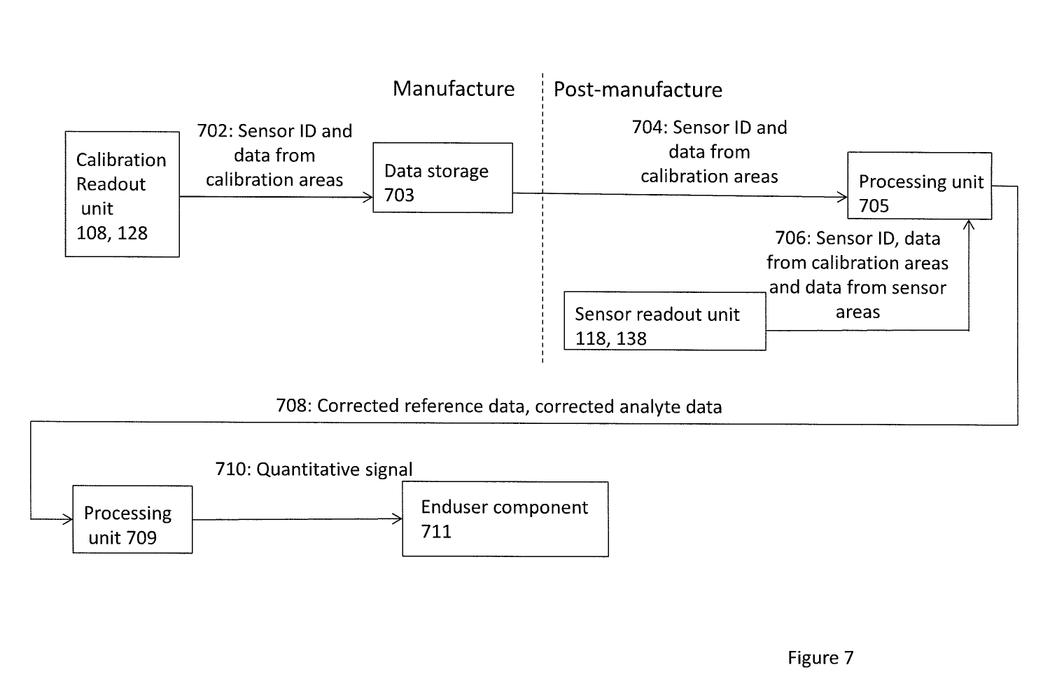

FIG. 8 illustrates a method for manufacturing a sensor according to an embodiment. FIGS. 1a to 1d illustrate examples of the sensor. The FIGS. 1a and 1c illustrate a sensor prior to its exposure to a fluid to be analysed and FIGS. 1b and 1d illustrate a sensor after subjecting the sensor to the fluid to be analysed. Prior to exposure to the fluid to be analysed the sensor may be a sensor in manufacturing and prior to distribution of the sensor to the endusers. After the sensor has been distributed to endusers the sensor may be referred to a post-manufacturing sensor. FIG. 7 illustrates an example of data flow in the method for communications of sensor responses, information identifying sensors and compensated sensor response.

The method for manufacturing a sensor may start 802, when a sensor that has a reading area comprising one or more calibration areas is exposed to stimuli and a calibration readout unit is arranged to read the reading area of the sensor. FIGS. 1a and 1c illustrate examples of the sensor. A sensor response of the sensor may be measured 804 during manufacturing of the sensor. During the manufacturing the sensor response may be measured by the calibration readout unit 108, 128. The measured sensor response of the sensor may be stored 806 to a network storage or a local memory. Information identifying the sensor may be stored with the sensor response or the sensor response may be stored in associated with information identifying the sensor in the network storage or the local memory. In this way the sensor response obtained during manufacturing may be stored such that sensor responses measured from the post-manufacturing sensor may be compensated on the basis of the sensor response measured during manufacturing.

The method may end 808 after the sensor response has been stored.

In an embodiment, a method for manufacturing the sensor may comprise printing the receptors for analyte molecules and the receptors for reference molecules and/or calibration are molecules a sensor surface. The calibration molecules may be printed prior to measuring 804 the sensor response such that a response from the calibration area may obtained for the measured 804 sensor response. The receptors for analyte molecules and the receptors for reference molecules may be printed also prior to measuring the sensor response or afterwards.

The sensor response may be stored to a network storage or a local memory, for example. Information identifying the sensor may be stored with the sensor response such that compensation of post-manufacturing sensor responses using the sensor response measured at manufacturing may be facilitated. The calibration readout unit may be operatively connected to the network storage to the local memory for storing data such as the sensor response and the information identifying the sensor. The calibration readout unit may be operatively connected to a processing unit capable causing the sensor response and/or the information identifying the sensor to be stored to the network storage or the local memory.

In one example, the local memory 112 may be a machine readable optical code, for example a bar code, and the processing unit is connected to a laser printing device capable of printing an optical code encoding the sensor response and/or the information identifying the sensor on the sensor.

In one example, the local memory 112 may be a discrete memory element with RFID access, and the processing unit is connected to an RFID writer capable of writing the sensor response and/or the information identifying the sensor on the sensor to the discrete memory element over an RFID connection to the discrete memory element.

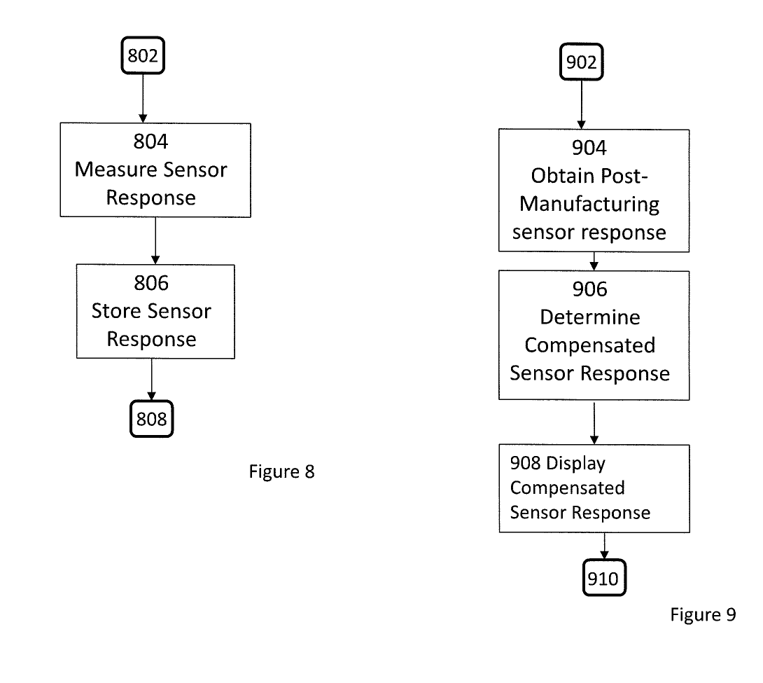

FIG. 9 illustrates a method for processing a post-manufacturing sensor response according to an embodiment. FIGS. 1a to 1d illustrate examples of the sensor. The FIGS. 1a and 1c illustrate a sensor prior to its exposure to a fluid to be analysed and FIGS. 1b and 1d illustrate a sensor after subjecting the sensor to the fluid to be analysed. Prior to exposure to the fluid to be analysed the sensor may be a sensor in manufacturing and prior to distribution of the sensor to the endusers. After the sensor has been distributed to endusers the sensor may be referred to a post-manufacturing sensor. FIG. 7 illustrates an example of data flow in the method for communications of sensor responses, information identifying sensors and a compensated sensor response.

The method for processing a post-manufacturing may start 902, when a sensor that has a reading area comprising one or more calibration areas and a sensing area is exposed to stimuli and a sensor readout unit is arranged to read the reading area of the sensor. A post-manufacturing sensor response of the sensor may be obtained 904 by the sensor readout unit 108, 128. The sensor response sensor may comprise values representing presence of analyte molecules and reference molecules and calibration molecules in the reading area of the sensor.

A compensated sensor response of the obtained sensor response, where the values of the sensor response are compensated on the basis of the sensor-specific sensor response measured at manufacturing of the sensor, may be determined 906.

The determined compensated sensor response may be caused to be displayed 908 to the enduser. The compensated sensor response may comprise a corrected reference signal and a corrected analyte signal or a quantitative signal. The compensated sensor response may be transmitted to a display device for displaying.

The method may end 910 after the compensated sensor response has been displayed to the enduser.

In various embodiments, connections between units for communicating data for example sensor responses, information identifying sensors, compensated sensor responses and/or quantitative signals may be provided by a data communications connections. A data communications connection may refer to a direct connection for communicating data or an indirect connection for communicating data. A direct connection for communication of data may be provided by a data bus or an electrical conductor. An indirect connection for communicating data may be provided by a processing unit capable of obtaining data from a source and communicating the data towards a destination. The indirect connection may be utilized, when the source of the data is different than the destination of the data. In one example the processing unit may communicate the obtained data without altering the data towards the destination. In another example, the processing unit may pre-process the data. Examples of the processing unit comprise a computing device capable of processing data, a handheld computing device, a smart phone, a tablet computer or a server. An enduser component may refer to a processing unit provided with a display such that a user may be displayed information. The display may be a touch screen such that the user may input commands to the enduser device. It should be appreciated that the enduser device may include additional or alternative input means to the touch screen for the user to enter commands to the enduser device.

In various embodiments, examples of the sources of data and destination for data may comprise the devices described with reference to the system of FIG. 7: a calibration readout unit, a sensor readout unit, a network storage, a local memory, a processing unit and an enduser component.

Discrete memory may comprise integrated circuit that is assembled on the sensor chip.

It will be obvious to a person skilled in the art that, as the technology advances, the inventive concept can be implemented in various ways. The invention and its embodiments are not limited to the examples described above but may vary within the scope of the claims.

1. An optical sensor for analyte molecules in a fluid, comprising a fluidic channel for fluid flow, said fluidic channel having a sensing area comprising receptors for reference molecules and the analyte molecules in the fluid, and the sensor comprises at least one calibration area comprising calibration molecules, and the at least one calibration area and the sensing area are arranged in a reading area of the sensor such that the sensor is capable of generating a sensor response, when the reading area is exposed to stimuli.

2. A sensor according to claim 1, wherein the sensor comprises a reference molecule area capable of releasing reference molecules, when subjected to fluid flow and the sensing area is located downstream from the reference area.

3. A sensor according to claim 1, wherein the sensor comprises at least two calibration areas arranged on opposite sides of the fluidic channel such that the sensing area is between the calibration areas.

4. A sensor according to claim 1, wherein a first sensor response is generated, when the reading area is exposed to stimuli prior to subjecting the sensor to a fluid and a second sensor response is generated, when the reading area is exposed to the stimuli after subjecting the sensor to the fluid flow.

5. A sensor according to claim 1, wherein the fluidic channel may comprise at least one of an inlet and an outlet, and the inlet may be capable of receiving the fluid to be analysed for transporting the fluid in the fluidic channel in a downstream direction towards the sensing area and the outlet may be capable of collecting or aspirating the fluid that has travelled in the fluidic channel past the sensing area.

6. A method for manufacturing a sensor according to claim 1, the method comprising:
measuring a sensor response during manufacturing of the sensor; and
storing the sensor response of the sensor to a network storage or a local memory.

7. A method according to claim 6, wherein the receptors for analyte molecules and the receptors for reference molecules and/or calibration molecules are printed on a sensor surface.

8. A system, comprising:
a storage for storing sensor-specific sensor responses measured at manufacturing of sensors according to claim 1,
a sensor readout unit for obtaining a post-manufacturing sensor response of a sensor,
a processing unit for processing the obtained post-manufacturing sensor response, and
an enduser component for delivering the processed sensor response values to the enduser,
wherein the storage, the sensor readout unit, the processing unit and the enduser component are operatively connected to cause:
obtaining a post-manufacturing sensor response of the sensor, said sensor response comprising values representing presence of analyte molecules and reference molecules and calibration molecules in the reading area of the sensor;
determining a compensated sensor response of the obtained sensor response, where the values of the sensor response are compensated on the basis of the sensor-specific sensor response measured at manufacturing of the sensor, and
causing to display the compensated sensor response to the enduser.

9. A system according to claim 8, wherein a ratio of the analyte molecules and the reference molecules indicated by the sensor response is maintained in the compensation.

10. A system according to claim 8, wherein the system is caused to determine one or more enduser-specific parameters and adjusting the compensated sensor response on the basis of the enduser-specific parameters.

11. A system according to claim 8, wherein the enduser specific parameters comprise a definition of enduser subscription and a request from the enduser.

12. A system according to claim 8, wherein the system is local to the sensor.

13. A system according to claim 8, wherein the system is a cloud service and capable of communicating to the sensor over an internet connection.

14. A method comprising:
obtaining a post-manufacturing sensor response of the sensor according to claim 1, said sensor response comprising values representing presence of analyte molecules and reference molecules and calibration molecules in the reading area of the sensor;
determining a compensated sensor response of the obtained sensor response, where the values of the sensor response are compensated on the basis of the sensor-specific sensor response measured at manufacturing of the sensor, and
causing to display the compensated sensor response to the enduser.
